(19) United States
(12) Patent Application Publication
(10) Pub. No.: US 2023/0392489 A1
(43) Pub. Date: Dec. 7, 2023

(54) METHOD, APPARATUS, AND SYSTEM FOR IDENTIFYING WELL STIMULATION CANDIDATES AND PERFORMING ACID STIMULATION ON THE IDENTIFIED CANDIDATES

(71) Applicant: Saudi Arabian Oil Company, Dhahran (SA)

(72) Inventors: Nasser Mubarak Al-Hajri, Abqaiq (SA); Syed Khalid M. Gilani, Abqaiq (SA)

(21) Appl. No.: 17/805,579

(22) Filed: Jun. 6, 2022

(51) Int. Cl. E21B 43/27; E21B 44/00

(52) U.S. Cl. CPC E21B 43/27; E21B 44/00; E21B 2200/20

(57) ABSTRACT

A method of prioritizing candidate natural resource production wells for acid stimulation, including: receiving well testing information associated with a plurality of natural resource production wells; identifying a respective skin factor for each of the plurality of natural resource production wells; modeling an inflow performance relationship and a vertical lift performance for each of the plurality of natural resource production wells based on the identified respective skin factor; forecasting a post-stimulation production increase based on the modeled inflow performance relationship and vertical lift performance, and a predetermined skin factor adjustment; determining an incremental reserve over cost metric based on the forecasted post-stimulation production increase; ranking the plurality of natural resource production wells according to the determined incremental reserve over cost metric; and outputting one or more control signals adapted to initiate acid stimulation of one or more top-ranked natural resource production wells.

### FIELD OF THE DISCLOSURE

The present disclosure generally relates to natural resource extraction management and, more specifically, to a system configured to identify well stimulation candidates and to perform acid stimulation on the identified candidates.

### BACKGROUND OF THE DISCLOSURE

It is well understood in the field of natural resource extraction that the output of a well declines over time. During the life cycle of an oil well or a gas well, the production rate may experience decline that requires stimulation of the well to increase its production rate. Well stimulation can be an acidizing work or nitrogen lift or any other well intervention jobs that result in a production gain. A well production gain from a stimulating job is defined as any increase in the production rate of an oil or gas well compared to pre-job rate as a baseline. The production gain arrests the general decline in production by the increase in rate compared to pre-job conditions.

Well stimulation work on an oil or gas well requires substantial financial investment. The investment must be prudently evaluated to ensure that any stimulating work provides a return on the investment in the form of sustainable production gain. As an example, stimulating a non-optimal candidate well can result in insufficient production gains to justify the cost associated with the stimulation.

### SUMMARY OF THE DISCLOSURE

Despite the prevalence of well stimulations, there has not been a unified streamlined process for evaluating and forecasting outcomes to identify optimal candidates for acid stimulation.

In view of the shortcomings of existing processes of extending the production lifecycle of oil and gas wells, it is an object of the present disclosure to provide an improved system, computing apparatus, and method to optimize well output enhancements by quantitatively identify most suitable candidates for acid stimulation.

According to one example implementation of the present disclosure, a method of prioritizing candidate natural resource production wells for acid stimulation comprises: receiving, by one or more processing apparatuses via a communication interface, well testing information associated with a plurality of natural resource production wells; identifying, by the one or more processing apparatuses, a respective skin factor for each of the plurality of natural resource production wells; modeling, by the one or more processing apparatuses, an inflow performance relationship and a vertical lift performance for each of the plurality of natural resource production wells based on the identified respective skin factor; forecasting, by the one or more processing apparatuses, a post-stimulation production increase based on the modeled inflow performance relationship, the modeled vertical lift performance, and a predetermined skin factor adjustment; determining, by the one or more processing apparatuses, an incremental reserve over cost metric for each of the plurality of natural resource production wells based on the forecasted post-stimulation production increase; ranking, by the one or more processing apparatuses, the plurality of natural resource production wells according to the determined incremental reserve over cost metric; and outputting, by the one or more processing apparatuses via the communication interface, one or more control signals adapted to initiate acid stimulation of one or more top-ranked natural resource production wells.

In one example implementation, the determining comprises: retrieving, by the one or more processing apparatuses, production histories of the plurality natural resource production wells; determining, by the one or more processing apparatuses, a cumulative production for each of the plurality natural resource production wells based the retrieved production histories; calculating, by the one or more processing apparatuses, a decline rate based on a relationship between an outcome of the decline rate and the determined cumulative production for each of the plurality natural resource production wells; applying, by the one or more processing apparatuses, the calculated decline rate to an initial production rate associated with the forecasted post-stimulation production increase for each of the plurality of natural resource production wells; and determining, by the one or more processing apparatuses, the incremental reserve over cost metric based on an estimated stimulation cost and a projected production from the applied decline rate.

In an example implementation, the decline rate is an exponential decline rate.

In one example implementation, the outcome of the decline rate is an estimated cumulative production associated with the decline rate.

In one example implementation, the relationship between the outcome of the decline rate and the determined cumulative production is a best fit between the estimated cumulative production associated with the decline rate and the determined cumulative production.

In one example implementation, the best fit corresponds to being within an acceptable variance ranging between about −3 percent and about +3 percent.

In one example implementation, the calculated decline rate is applied to the initial production rate at a projected stimulation time.

In one example implementation, the incremental reserve over cost metric incorporates a projected non-stimulated production for each of the plurality of natural resource production wells.

In an example implementation, the method further comprises: initiating, by one or more acid stimulation systems, acid stimulation of the one or more top-ranked natural resource production wells based on one or more parameters included in the one or more control signals.

According to an example implementation of the present disclosure, an apparatus adapted to prioritize candidate natural resource production wells for acid stimulation, comprises: a processor; a communication interface to one or more networks; and a non-transitory computer-readable memory operatively connected to the one or more processors and having stored thereon machine-readable instructions to: receive, via the communication interface, well testing information associated with a plurality of natural resource production wells; identify a respective skin factor for each of the plurality of natural resource production wells; model an inflow performance relationship and a vertical lift performance for each of the plurality of natural resource production wells based on the identified respective skin factor; forecast a post-stimulation production increase based on the modeled inflow performance relationship, the modeled vertical lift performance, and a predetermined skin factor adjustment; determine an incremental reserve over cost metric for each of the plurality of natural resource production wells based on the forecasted post-stimulation production increase; rank the plurality of natural resource production wells according to the determined incremental reserve over cost metric; and output, via the communication interface, one or more control signals adapted to initiate acid stimulation of one or more top-ranked natural resource production wells.

In one example implementation, the machine-readable instructions further comprise, for the (5) determine element, instructions to: retrieve production histories of the plurality natural resource production wells; determine a cumulative production for each of the plurality natural resource production wells based the retrieved production histories; calculate a decline rate based on a relationship between an outcome of the decline rate and the determined cumulative production for each of the plurality natural resource production wells; apply the calculated decline rate to an initial production rate associated with the forecasted post-stimulation production increase for each of the plurality of natural resource production wells; and determine the incremental reserve over cost metric based on an estimated stimulation cost and a projected production from the applied decline rate.

In one example implementation, the decline rate is an exponential decline rate.

In one example implementation, the outcome of the decline rate is an estimated cumulative production associated with the decline rate.

In one example implementation, the relationship between the outcome of the decline rate and the determined cumulative production is a best fit between the estimated cumulative production associated with the decline rate and the determined cumulative production.

In one example implementation, the best fit corresponds to being within an acceptable variance ranging between about −3 percent and about +3 percent.

In one example implementation, the calculated decline rate is applied to the initial production rate at a projected stimulation time.

In one example implementation, the incremental reserve over cost metric incorporates a projected non-stimulated production for each of the plurality of natural resource production wells.

According to one example implementation of the present disclosure, a system comprises: an apparatus adapted to prioritize candidate natural resource production wells for acid stimulation, comprising: a processor; a communication interface to one or more networks; and a non-transitory computer-readable memory operatively connected to the one or more processors and having stored thereon machine-readable instructions to: receive, via the communication interface, well testing information associated with a plurality of natural resource production wells; identify a respective skin factor for each of the plurality of natural resource production wells; model an inflow performance relationship and a vertical lift performance for each of the plurality of natural resource production wells based on the identified respective skin factor; forecast a post-stimulation production increase based on the modeled inflow performance relationship, the modeled vertical lift performance, and a predetermined skin factor adjustment; determine an incremental reserve over cost metric for each of the plurality of natural resource production wells based on the forecasted post-stimulation production increase; rank the plurality of natural resource production wells according to the determined incremental reserve over cost metric; and output, via the communication interface, one or more control signals adapted to initiate acid stimulation of one or more top-ranked natural resource production wells; and one or more acid stimulation systems adapted to initiate acid stimulation of the one or more top-ranked natural resource production wells based on one or more parameters included in the one or more control signals.

### BRIEF DESCRIPTION OF THE DRAWING FIGURES

Various example implementations of this disclosure will be described in detail, with reference to the following figures, wherein:

FIG. 1 is a schematic illustration of one example implementation of the present disclosure.

FIG. 2 is a flow diagram of an overall process for identifying and prioritizing well stimulation candidates and conducting acid stimulation on prioritized candidates in accordance with an example implementation of the present disclosure.

FIG. 3 is a log-log graph plot of a pressure and a pressure derivative for a producing well in a pseudosteady state over time to illustrate a representation of the “skin” factor.

FIG. 4 is a pressure to flow rate graph plot illustrating an output of an inflow performance relationship (IPR) model and a tuning target for the model according to an example implementation of the present disclosure.

FIG. 5 is a schematic illustration of a natural resource extraction well with captioned indicators for all pressure losses from reservoir to separator of the well.

FIG. 6 is a pressure to flow rate graph plot that conceptually illustrates a relationship between the IPR model and a vertical lift performance (VLP) model according to an example implementation of the present disclosure.

FIG. 7 is a pressure to production rate graph plot that conceptually illustrates a skin factor adjustment employed for a post-stimulation production forecast in accordance with an example implementation of the present disclosure.

FIG. 8 is a flow diagram of a candidate well stimulation estimation process according to an example implementation of the present disclosure, which process corresponds with step s220 of FIG. 2.

### DETAILED DESCRIPTION OF CERTAIN EMBODIMENTS OF THE DISCLOSURE

As an overview, well stimulation in various forms have been used in the oil and gas industry for improving well production. Such stimulation work has usually been performed based on ad hoc analyses of wells that exhibit declines in production. As a result, these operations may be inefficient in failing to prioritize candidate wells that would benefit most from stimulation. At the same time, resources may be devoted to stimulating underperforming wells that would not benefit from stimulation to a sufficient degree to justify the resources spent, especially when compared to other wells that might benefit from stimulation. The inefficiencies in evaluating stimulation candidates and their associated opportunity costs have not been addressed to a sufficient degree in the industry. There has been a long felt and unmet need for an efficient systemwide analytical process for prioritizing stimulation candidates based on both pre-stimulation and forecasted post-stimulation production.

The present disclosure concerns improving the process of identifying candidate natural resource wells for stimulation. It also provides insights for production planning and forecast by quantifying the expected incremental gains in the field development cycles. More specifically, the present disclosure concerns a novel process for identifying and prioritizing well candidates for acid stimulation based on both pre-stimulation and forecasted post-stimulation production. The novel process includes conducting acid stimulation on the identified optimal well candidates.

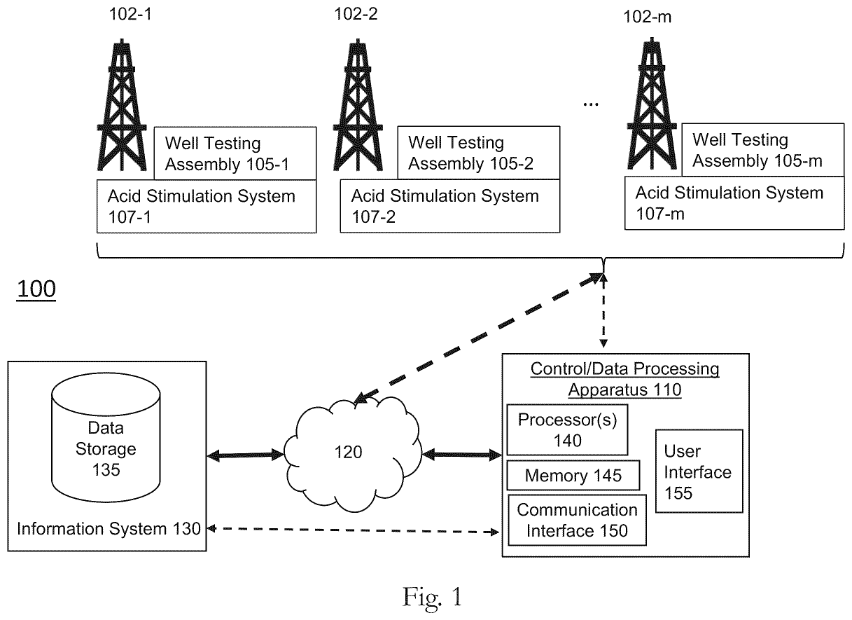

FIG. 1 is a schematic illustration of one example implementation of the present disclosure. It is understood that alternative apparatus, network, and system structures can be implemented without departing from the spirit and scope of the present disclosure. For example, one or more of the devices, apparatuses, and systems shown in FIG. 1, and as described below, can be divided into plural entities. Conversely, the features and functionality provided by any plural entities shown in FIG. 1, and as described below, can be provided by a consolidated apparatus with suitable programming and attendant hardware components to provide such features and functionality.

As shown in FIG. 1, system 100 includes a plurality of natural resource (e.g., oil or gas) wells 102-1, 102-2, . . . , 102-m (which, hereinafter, may be collectively referred to with 102) that are communicatively coupled to a control/data processing apparatus 110 via a network 120. As further illustrated in FIG. 1, wells 102-1, 102-2, . . . , 102-m incorporate respective well testing assemblies 105-1, 105-2, . . . , 105-m (which, hereinafter, may be collectively referred to with 105) and respective acid stimulation systems 107-1, 107-2, . . . , 107-m (which, hereinafter, may be collectively referred to with 107). In certain implementations, one or more of wells 102-1, 102-2, . . . , 102-m incorporate control device(s)(not shown) for their respective operations and/or those of their respective well testing assemblies 105-1, 105-2, . . . , 105-m and acid stimulation systems 107-1, 107-2, . . . , 107-m. In one example implementation, the well testing, candidate well identification, and acid stimulation process of the present disclosure is conducted on an overall extraction system with wells in the tens of thousands (e.g. m˜40,000).

Data from well testing by the respective well testing assemblies 105-1, 105-2, . . . , 105-m are collected by control/data processing apparatus 110. In example implementations, well testing assemblies 105 include those for conducting surface flow and pressure testing, surface shut-in testing, downhole shut-in well testing, downhole flow and pressure measurements, buildup testing, flash vaporization PVT (pressure-volume-temperature) well testing, well deviation surveys, reservoir testing (e.g., on multiple wells 102 from a same reservoir), well logging, to name a few. In certain implementations, the testing data can be recorded at the respective wells 102 (e.g., by respective controllers for assemblies 105) and forwarded directly to information system 130 via network 120 for storing the collected well testing data in data storage 135. Processing of the collected well testing data is conducted by control/data processing apparatus 110, which can receive raw data from assemblies 105 when it is collected and/or retrieve stored data from information system 130.

As illustrated in FIG. 1, control/data processing apparatus 110 is a computing apparatus that incorporates one or more processor devices 140, a memory 145, a communication interface 150, and a user interface 155. One or more processor(s) 140 can include any suitable processing circuitry capable of controlling operations and functionality of control/data processing apparatus 110, as well as facilitating communications between various components within control/data processing apparatus 110. In some embodiments, processor(s) 140 can include a central processing unit (“CPU”), a graphic processing unit (“GPU”), one or more microprocessors, a digital signal processor, or any other type of processor, or any combination thereof.

Memory 145 can include one or more types of storage mediums such as any volatile or non-volatile memory, or any removable or non-removable memory implemented in any suitable manner to store data for control/data processing apparatus 110. For example, information can be stored using computer-readable instructions, data structures, and/or program systems. Several types of storage/memory can include, but are not limited to, hard drives, solid state drives, flash memory, permanent memory (e.g., ROM), electronically erasable programmable read-only memory (“EEPROM”), CD ROM, digital versatile disk (“DVD”) or other optical storage medium, magnetic cassettes, magnetic tape, magnetic disk storage or other magnetic storage devices, RAID storage systems, or any other storage type, or any combination thereof. Furthermore, memory 145 can be implemented as computer-readable storage media (“CRSM”), which can be any available physical media accessible by processor(s) 140 to execute one or more instructions stored within memory 145. In some embodiments, one or more applications can be run by processor(s) 140 and can be stored in memory 145.

Communication interface 150 can include any circuitry allowing or enabling one or more components of control/data processing apparatus 110 to communicate with one or more additional devices, servers, and/or systems—for example, one or more of information system 130, well testing assemblies 105, acid stimulation systems 107, and any other controllable components of wells 102 (not shown). As an illustrative example, data recorded by well testing assemblies 105-1 . . . 105-m can be transmitted to control/data processing apparatus 110 using any number of communications protocols either directly or over network 120. For example, network(s) 120 can be accessed using Transfer Control Protocol and Internet Protocol (“TCP/IP”) (e.g., any of the protocols used in each of the TCP/IP layers), Hypertext Transfer Protocol (“HTTP”), WebRTC, SIP, and wireless application protocol (“WAP”), are some of the various types of protocols that can be used to facilitate communications between control/data processing apparatus 110 and information system 130, well testing assemblies 105, acid stimulation systems 107, and any other controllable components of wells 102 (not shown). Various additional communication protocols can be used to facilitate communications among control/data processing apparatus 110, information system 130, well testing assemblies 105, acid stimulation systems 107, and any other controllable components of wells 102 (not shown). These include the following non-exhaustive list, Wi-Fi (e.g., 802.11 protocol), Bluetooth, radio frequency systems (e.g., 900 MHz, 1.4 GHz, and 5.6 GHz communication systems), cellular networks, FTP, RTP, RTSP, SSH, to name a few.

User interface 155 is operatively connected to processor(s) 140 and can include one or more input or output device(s), such as switch(es), button(s), key(s), a touch screen, a display, microphone, camera(s), sensor(s), etc. as would be understood in the art of electronic computing devices. Display of user interface 155 can be used to display the candidate well prioritization and an operator can confirm acid stimulation (via systems 107) of the identified candidate wells (102). Alternatively, the stimulation can be automated based on the prioritization and recorded for performance review by an operator.

Communications systems for facilitating network 120 can include hardware (e.g., hardware for wired and/or wireless connections) and/or software. In certain implementations, communications systems can include one or more communications chipsets, such as a GSM chipset, CDMA chipset, LTE chipset, 4G/5G/6G, Wi-Fi chipset, Bluetooth chipset, to name a few, and/or combinations thereof. Wired connections can be adapted for use with cable, plain old telephone service (POTS) (telephone), fiber (such as Hybrid Fiber Coaxial), xDSL, to name a few, and wired connections can use coaxial cable, fiber, copper wire (such as twisted pair copper wire), and/or combinations thereof, to name a few. Wired connections can be provided through telephone ports, Ethernet ports, USB ports, and/or other data ports, such as Apple 30-pin connector ports or Apple Lightning connector ports, to name a few. Wireless connections can include cellular or cellular data connections and protocols (e.g., digital cellular, PCS, CDPD, GPRS, EDGE, CDMA2000, 1×RTT, RFC 1149, Ev-DO, HSPA, UMTS, 3G, 4G, LTE, 5G, and/or 6G to name a few), Bluetooth, Bluetooth Low Energy, Wi-Fi, radio, satellite, infrared connections, ZigBee communication protocols, to name a few. Communications interface hardware and/or software, which can be used to communicate over wired and/or wireless connections, can include Ethernet interfaces (e.g., supporting a TCP/IP stack), X.25 interfaces, T1 interfaces, and/or antennas, to name a few. Computer systems—such as control/data processing apparatus 110 and information system 130 (and any control device (not shown) integrated with assemblies 105 and systems 107)—can communicate with other computer systems or devices directly and/or indirectly, e.g., through a data network, such as the Internet, a telephone network, a mobile broadband network (such as a cellular data network), a mesh network, Wi-Fi, WAP, LAN, and/or WAN, to name a few.

Information system 130 incorporates data storage 135 that embodies storage media for storing data from well testing assemblies 105-1 . . . 105-m, control/data processing apparatus 110, and acid stimulation systems 107-1 . . . 107-m (such as stimulation parameters). Exemplary storage media for data storage 135 correspond to those described above with respect to memory 145, which will not be repeated here. In embodiments, information system 130 incorporates one or more database servers that support NoSQL, MySQL, Oracle, SQL Server, NewSQL, and/or the like. Information system 130 incorporates a communication interface (not shown) for communications with the aforementioned entities—i.e., assemblies 105, systems 107, control/data processing apparatus 110—and exemplary implements of which can include those described above with respect to communication interface 150, which will not be repeated here.

In certain implementations, the functionality of apparatus 110 can be divided/delegated to multiple apparatuses or systems that are communicatively coupled to apparatus 110 and/or information system 130, assemblies 105, and systems 107. As an example, the collection of well testing data from assemblies 105 can be conducted, at least in part, by a portable device embodying certain functionality of control/data processing apparatus 110. Accordingly, the data collection can be conducted onsite by an engineer at one or more of wells 102. In other implementations, certain functionality of apparatus 110 can also be performed by information system 130. For example, the processing of collected production data and the candidate well prioritization processing can be performed, at least in part, by information system 130. In such implementations, information system 130 can further incorporate one or more processors (not shown) to conduct the data processing, example implements of which correspond to those of processor(s) 140. Alternatively, in some implementations, the processing of collected production data and the candidate well prioritization processing can be performed, at least in part, by one or more server apparatuses (e.g., an application server)(not shown) that is communicatively coupled to network 120. Additionally, separate and independent control devices (not shown) can be incorporated at wells 102 for communicating with information system 130 (and/or apparatus 110) and controlling acid stimulation systems 107 based upon results of the candidate well prioritization. In other words, computing devices and/or data processing apparatuses capable of embodying the systems and/or methods described herein can include any suitable type of electronic device including, but are not limited to, servers, desktop computers, mobile computers (e.g., laptops, ultrabooks), mobile phones, portable computing devices, such as smart phones, tablets, personal display devices, personal digital assistants (“PDAs”), virtual reality devices, wearable devices (e.g., watches), controllers, to name a few.

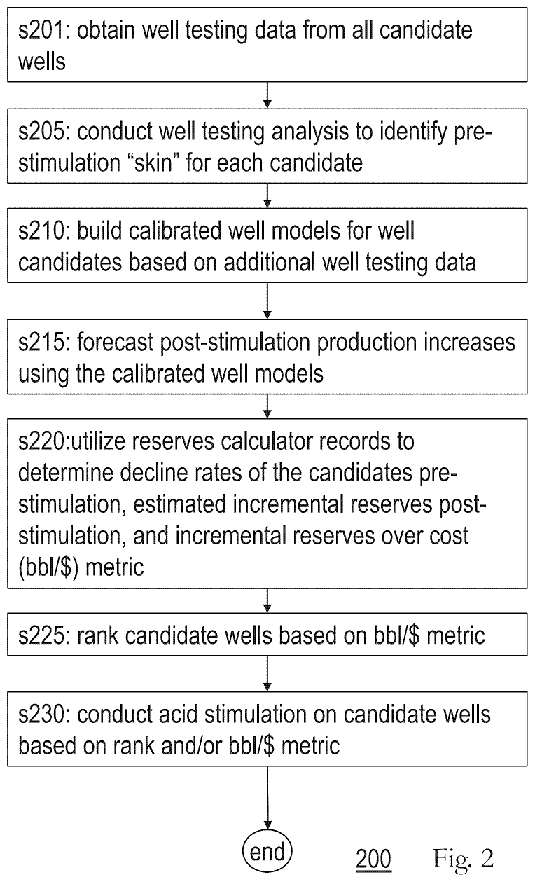

FIG. 2 is a flow diagram of an overall process 200 for identifying and prioritizing well stimulation candidates and conducting acid stimulation on the prioritized candidates in accordance with an example implementation of the present disclosure.

As shown in FIG. 2, process 200 initiates at step s201 by obtaining and collecting well testing data from all candidate wells (102). In an example implementation, step s201 is conducted by control/data processing apparatus 110, which collects well testing data from assemblies 105. As noted before, assemblies 105 can include those for conducting surface flow and pressure testing, surface shut-in testing, downhole shut-in well testing, downhole flow and pressure measurements, buildup testing, flash vaporization PVT (pressure-volume-temperature) well testing, well deviation surveys, reservoir testing (e.g., on multiple wells 102 from a same reservoir), well logging, to name a few. In certain implementations, the well testing data can be independently conducted and stored at information system 130 for recordkeeping and later processing. In such implementations, step s201 can include control/data processing apparatus 110 retrieving the well testing data from information system 130 for processing. Alternatively, information system 130 can retrieve the well testing data for processing.

Next, process 200 proceeds to step s205 where control/data processing apparatus 110 and/or information system 130 conduct well testing analysis to identify the pre-stimulation “skin” for each candidate well (102). The “skin” of a natural resource (e.g., oil or gas) extraction well (e.g., 102) is understood to be a reference to a zone around a wellbore, which may suffer from reduced permeability—and, thus, reduced flow—due to formation damage, obstructions (e.g., sand intrusion), etc. It is represented by a dimensionless factor—skin factor (S)—that reflects the production efficiency of a well (102) due to characteristics in this zone around the wellbore, with a positive value indicating impaired productivity and a negative value indicating enhanced productivity (e.g., resulting from stimulation). The zone can be referred to as the skin zone.

In an example implementation of the present disclosure, the “skin” is determined by conducting pressure buildup analyses on wells 102. The output of such analyses include:
1—A permeability thickness product, derived from Infinite Acting Radial Flow horizontal line on a Delta P curve in a log-log derivative plot; and
2—The skin, which is derived from a distance between the Delta P curve and the Delta P Derivative curve on the log-log derivative plot.

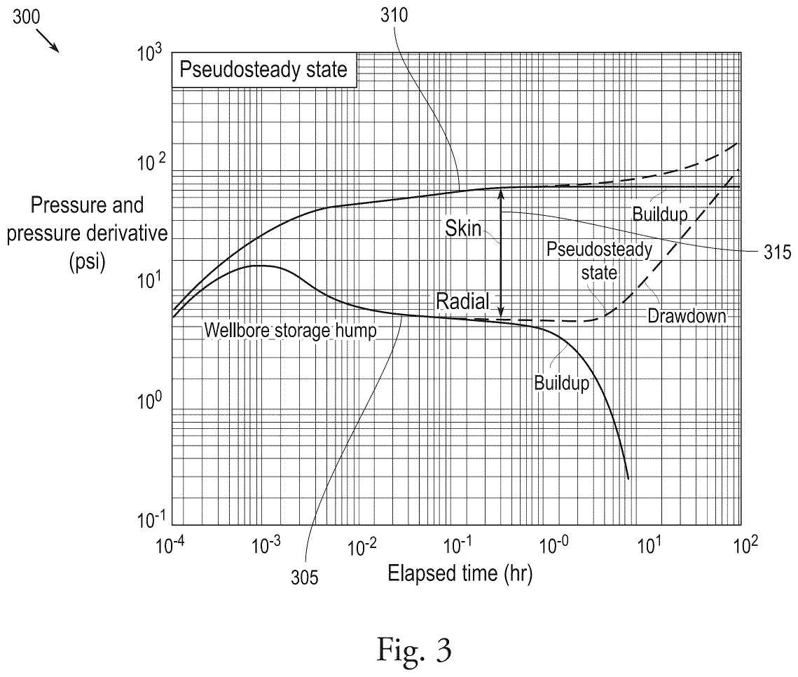

The permeability thickness is a product of a formation permeability (k) and a producing formation thickness (h) in a producing well (102). According to an example implementation, the kh is derived by matching the radial portion of a model to well test points that are horizontal/flat in the Middle Time Region. FIG. 3 is a sample log-log graph plot 300 of a well pressure (Delta P curve 305)(in pounds per square inch (psi)) and a pressure derivative (derivative curve 310)(in psi) of a producing well (102) in a pseudosteady state over time (elapsed time in hours (hr))(See Schlumberger (2002). FIG. 26(a), Interpretation Review. In Well Test Interpretation (p. 37). Schlumberger). As shown in FIG. 3, a horizontal/flat in the Middle Time Region on curve 305 is marked “Radial” to denote the radial portion of the well test points. FIG. 3 further includes a pressure derivative curve 310. The skin becomes larger as the gap between the curve 305 and curve 310 becomes larger. Accordingly, reservoir engineers plot time-lapse well testing analysis derivative plots to understand if skin is increasing with time or has decreased after a well stimulation job.

After the permeability thickness (kh) is obtained, the permeability is calculated based on the net thickness from the well log (e.g., from assemblies 105 or other production output measurement device(s)(not shown)). According to an example implementation, the net thickness is the thickness open to flow to the phase used in the well testing analysis input. For example, in a gas well, gas rates vs. time and pressure vs. time and a net thickness above Gas-Water contact only are used to determine the permeability and permeability thickness.

According to one example implementation, a skin factor of at least about one (1) identifies a well 102 as a candidate for the following prioritization and acid stimulation.

Once the pre-stimulation skin for each candidate well 102 is determined, process 200 proceeds to step s210, where calibrated predictive well models are built for all of the candidate wells 102 (e.g., those of wells 102 with an above-threshold skin factor) based on additional well testing data obtained at step s201.

According to one example implementation, an inflow performance relationship (IPR) model and a vertical lift performance (VLP) model is constructed for each candidate well (102) at step s210. The fully calibrated well models are built to predict candidate well performance after stimulation.

The following information is obtained (at step s201 and/or at step s210 of process 200) for the respective candidate wells 102 for building the models:
1—PVT (Pressure-Volume-Temperature) information for the reservoir of the candidate well (102);
2—Well Deviation Survey;
3—Well Completion Schematic;
4—Most recent static survey from the candidate well (102) and/or from an offset well (102) producing from the same reservoir;
5—Reservoir Rock Properties, such as Reservoir Thickness and Permeability and Skin;
6—Recent Well Test; and
7—Artificial Lift Parameters.

In an example implementation, the above information (1-7) is obtained and recorded at information system 130 on a regular basis and, thus, control/data processing apparatus 110 builds the IPR and VLP models based on data retrieved from information system 130 at step s210. In some implementations, at least a portion of the above information (1-7) can be recorded at assemblies 105 and retrieved by control/data processing apparatus 110 for building the IPR and VLP models.

1—PVT Information

According to an example implementation, PVT data is used for both Inflow Performance Relationship (IPR) modeling and Vertical Lift Performance (VLP) modeling to account for hydrocarbon volume changes as it flows from a region of high pressure and high temperature (e.g., reservoir) to a region of lower pressure and temperature (e.g., wellhead). As an example, black oil PVT properties include solution gas-oil ratio (GOR), oil gravity (e.g., American Petroleum Institute (API) gravity), gas gravity, produced water salinity, and impurities concentration (such as H₂S, CO₂, and N₂).

Flash vaporization PVT test data can be used to calibrate PVT correlations to fluid properties of specific reservoirs.

2—Well Deviation Survey

In example implementations, well deviation survey data is obtained for the candidate wells (102) to measure departure (or deviation) of borehole directions from planned borehole directions (in degrees), where assemblies (105) can include mechanical drift recorders (e.g., Totcos), measurement while drilling (MWD) tools, accelerometers, gyroscopes, to name a few. In certain implementations, the well deviation survey can be obtained from the well logs of the candidate wells 102.

3—Well Completion Schematic

The well completion schematic includes information on the installation and assembly of piping and other equipment used in well completion after the drilling process for the candidate well (102). In an example implementation, the well completion schematic is recorded at information system 130 for wells 102 as well completion is performed and completed at the respective wells 102.

4—Most Recent Static Survey from the Candidate Well (e.g., 102-1) and/or from an Offset Well (e.g., 102-2) Producing from the Same Reservoir

Static surveys include static pressure surveys and static temperature surveys of candidate wells 102. In example implementations, the static survey can include a pressure transient test, such as a short-duration buildup test of any kind (including wireline pressure “pretests”). As a result, one of the interpretation outputs of such a survey(s) is the static pressure of the reservoir of the candidate well (e.g., 102-1) and the offset well (e.g., 102-2).

5—Reservoir Rock Properties, Such as Reservoir Thickness and Permeability and Skin

The reservoir rock properties is are obtained from the above-described skin and kh determinations at step s205 of process 200 for multiple candidate wells (e.g., 102-1 and 102-2) extracting from the same reservoir according to one example implementation of the present disclosure.

6—Recent Well Test

Recent well test information includes water cut, total GOR (producing GOR), and the like, which are obtained from assemblies 105 (or information system 130) at step s201.

7—Artificial Lift Parameters

Artificial Lift Parameters are parameters associated with any artificial lifts conducted on the candidate wells 102. Systems for conducting the artificial lifts can include any pumping, gas lift, or hybrid systems. Thus, the artificial lift parameters are those in connection with these systems for any artificial lifts that have been conducted on the respective candidate wells 102.

Inflow Performance Relationship

The productivity index (PI) relationship has been commonly used to model the inflow performance relationship (IPR) of a well. The equation of Productivity Index in terms of fluid flow rate (Q), reservoir pressure (Pᵣₑₛₑᵣᵥₒᵢᵣ), and sandface flowing bottomhole pressure (P_{sandface}) is listed below (See Ahmed, T. (2006). Oil Well Performance and Gas Well Performance. In Reservoir Engineering Handbook (3^{rd} ed.)(pp. 484-582). Gulf Professional Publishing.):

$$Productivity Index = \frac{Q}{{P}_{reservoir} - {P}_{sandface}} \qquad ( 1 )$$

However, skin factors are integrated in the Productivity Index term of equation (1). One of the main objectives for acidizing a well (e.g., via acid stimulation) is to reduce skin and thereby improve well production rate. Consequently, an IPR model where skin is entered independently is needed to account for skin factor changes when forecasting post-stimulation performance. Thus, according to one example implementation, the Darcy Inflow equation for steady state flow or pseudo-state state flow is used for modeling performance of each candidate well (102). The Darcy model has been used for vertical and deviated wells. Below is the equation for Darcy inflow model for pseudo-steady state flow (See Well Inflow Performance. In Production Technology: Performance of Flowing Wells (pp. 3-26). Institute of Petroleum Engineering, Heriot Watt University):

$$q = \frac{kh}{141.2 B μ \{ ln \frac{{r}_{e}}{{r}_{w}} - \frac{3}{4} + S + Dq )} ( {\overline{P}}_{R} - {P}_{wf} ) \qquad ( 2 )$$

where,
i. q=reservoir flow rate, in cm³/sec (or stock tank barrel (STB)/day)
ii. k=absolute permeability, in Darcy (or reservoir permeability)
iii. h=thickness, in cm or ft
iv. rₑ=drainage radius, in cm or ft
v. r_{w}=well bore radius, in cm or ft
vi. B=(oil) formation volume factor
vii. μ=viscosity, in centipoise (cp)
viii. S=skin, dimensionless factor
ix. D=non-Darcy (turbulence) factor
x. P_{R}=reservoir pressure, which can be measured by a stabilized bottomhole pressure with the well shut in, in pounds per square in gauge (psig); P̅_{R}=measured maximum of reservoir pressure
xi. P_{wf} (or FBHP)=the flowing, bottom hole, wellbore pressure at one production rate, in psig

Thus, the IPR model for each candidate well (102) is constructed based on the above factors obtained at step s201 (and/or at step s210). For example, the reservoir pressure (P R) is obtained via a static pressure survey, as described above, conducted at a candidate well (e.g., 102-1) and/or one or more offset wells (e.g., 102-2). A reservoir temperature is also obtained via a static survey (e.g., static temperature survey), which reservoir temperature is used to calculate an oil formation volume factor (in addition to the reservoir pressure). A water cut, which is a volume ratio of water produced to total liquids produced, is obtained from recent well tests conducted at the candidate wells 102 (e.g., by assemblies 105). Correspondingly, total GOR (solution gas-oil ratio) is also obtained from such tests at the candidate wells 102 (e.g., by assemblies 105). Reservoir permeability (k) is determined based on the permeability (k) obtained when determining the pre-stimulation skin factor at step s205. The reservoir thickness (h) is the vertical thickness that is adjusted for any well deviation based on the pre-stimulation skin determined at step s205. As discussed above, well deviation can be determined via well deviation surveys. Drainage radius (rₑ) is obtained, for example, from reservoir simulations or well test analyses. Wellbore radius (r_{w}) is obtained, for example, from the well completion schematics described above. It is noted that wellbore radius is of the wellbore and not of the casing within it.

Accordingly, the skin factor (S) is an independently input parameter and, for the initial IPR model of each candidate well (102), the skin determined at step s205 is used.

In one example implementation, the IPR model for each candidate well (102) is tuned based on one or more most recent downhole flowing pressure measurement(s) (e.g., flowing bottomhole pressure, “FBHP”).

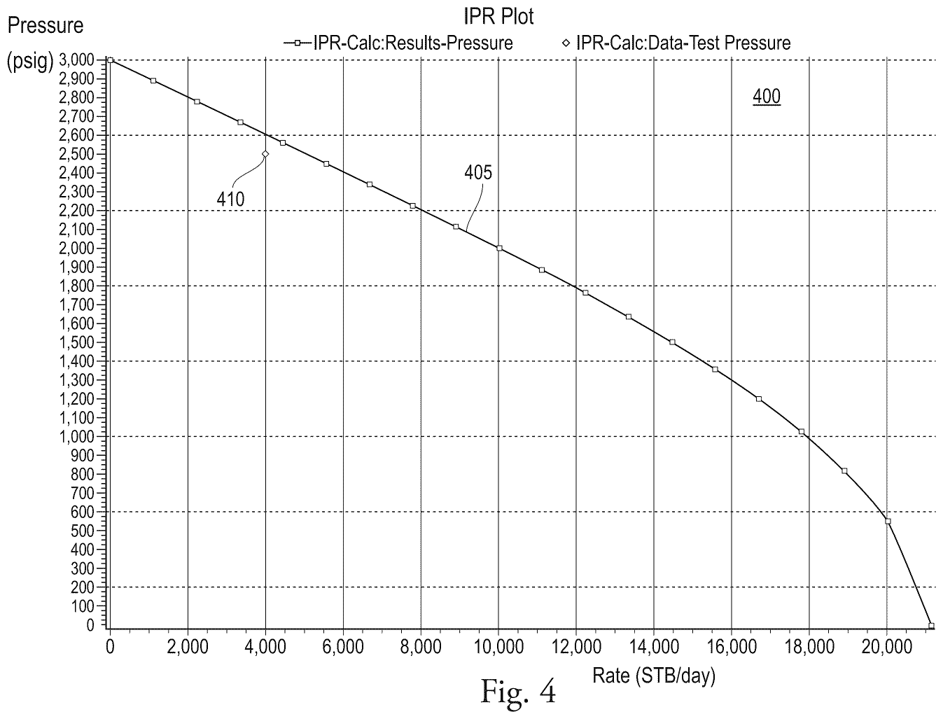

FIG. 4 is a pressure (psig) to flow rate (STB/day) graph plot 400 of an IPR model curve 405 of one candidate well (102) against a recent FBHP data point 410 for the same candidate well (102). As shown in FIG. 4, data point 410 is a short distance from curve 405. Thus, according to an example implementation of the present disclosure, the IPR model curve (405) is tuned by adjusting the permeability (k) and/or the skin (S) factor for a best fit to the most recent FBHP survey data. As discussed before, the permeability (k) and/or the skin (S) factor are determined at step s205 and used for building the IPR model at step 210. The tuning involves adjustments to these factors. For the example of FIG. 4, the skin (S) factor is increased to adjust curve 405 towards point 410. As understood from equation (2), an increase of skin (S) factor and/or a decrease of permeability (k) would shift curve 405 leftward (or downward) towards point 410.

The IPR model described so far is most applicable to vertical wells. With respect to horizontal wells, any applicable horizontal well method that expresses skin directly can be used in certain implementations.

Vertical Lift Performance Relationship

The next step in building a calibrated well model is to build the Vertical Lift Performance (VLP) model. In example implementations, several flow correlations can be used to build the VLP model, such as Petroleum Experts™, Beggs and Brill, OLGA™, etc. An appropriate flow correlation is selected based on fluid type and well deviation. According to one example implementation, the VLP model is build using the aforementioned: 1—PVT information, 2—Well Deviation Survey, 3—Well Completion Schematic, and 7—Artificial Lift Parameters.

As understood, the IPR model accounts for the relationship between the reservoir and well rate and the VLP model accounts for the relationship between pressure losses/gains (from artificial lift) in the well and well rate. Based upon the relationships, the IPR is coupled with the VLP to determine an actual well rate.

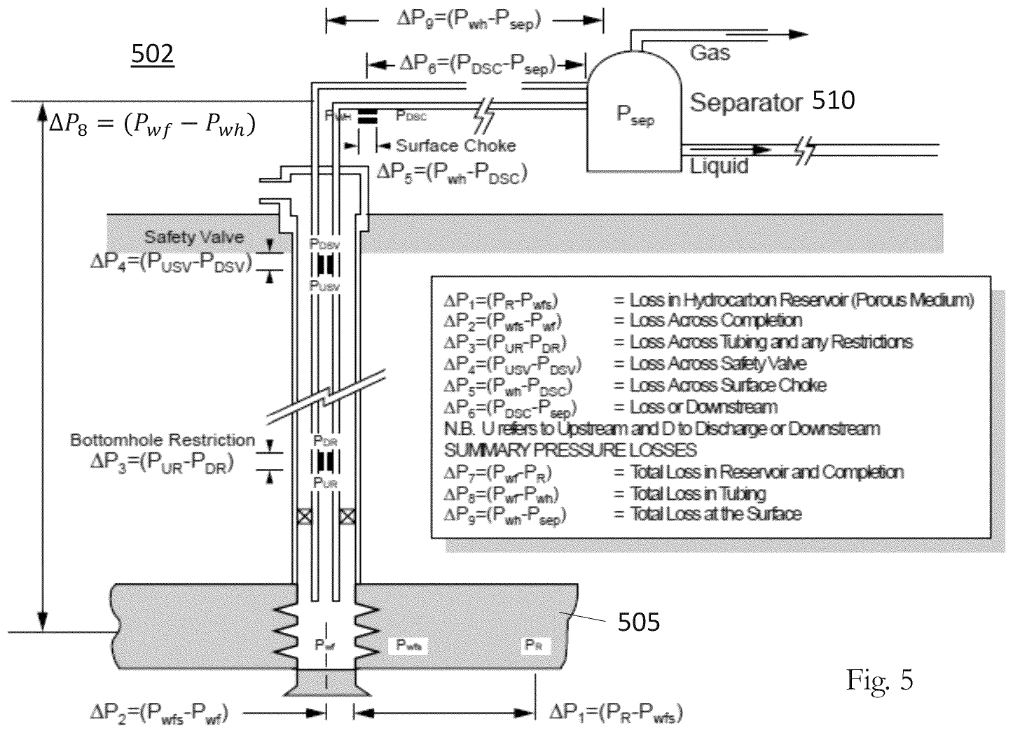

FIG. 5 is a schematic illustration of a natural resource extraction well 502 with captioned indicators for all pressure losses from the reservoir 505 to the separator 510. (See FIG. 2, Well Performance. In Production Technology (p. 4). Institute of Petroleum Engineering, Heriot-Watt University).

In FIG. 5, the captioned parameters refer to the following:
P_{R}=Reservoir Pressure
P_{wfs}=Flowing sand face Pressure
P_{wf}=Flowing Bottom Hole Pressure
P_{UR}=Upstream Restriction Pressure
P_{DR}=Downstream Restriction Pressure
P_{USV}=Upstream Safety Valve Pressure
P_{DSV}=Downstream Safety Valve Pressure
P_{WH}=Well Head Pressure
P_{DSC}=Downstream surface Choke Pressure
Pₛₑₚ=Separator Pressure
ΔP₁=(P_{R}−P_{wfs})=Loss in Hydrocarbon Reservoir (Porous Medium)
ΔP₂=(P_{wfs}−P_{wf})=Loss Across Completion
ΔP₃=(P_{UR}−P_{DR})=Loss Across Tubing and any Restrictions
ΔP₄=(P_{USV}−P_{DSV})=Loss Across Safety Valve
ΔP₅=(P_{wh}−P_{DSC})=Loss Across Surface Choke
ΔP₆=(P_{DSC}−Pₛₑₚ)=Loss or Downstream
N.B. U refers to Upstream and D to Discharge or Downstream

Summary Pressure Losses
ΔP₇=(P_{wf}−P_{R})=Total Loss in Reservoir and Completion
ΔP₈=(P_{wf}−P_{wh})=Total Loss in Tubing
ΔP₉=(P_{wh}−Pₛₑₚ)=Total Loss at the Surface

In an example implementation of the present disclosure, some of the above pressure losses are reconfigured to well measurement data to improve accounts for such losses in the IPR and VLP models.

For example:
i. P_{R} is replaced with P̅_{R} (measured maximum) for reservoir pressure;
ii. accordingly, ΔP₁=(P̅_{R}−P_{wfs}); and
iii. ΔP₇=(P̅_{wf}−P_{wf}), flowing bottom hole pressure subtracted from its measured maximum.

The IPR model accounts for ΔP₁ and ΔP₂ noted above and the VLP model accounts for ΔP₃ and ΔP₄. An actual well rate is, thus, determined by obtaining an intersection between these two models.

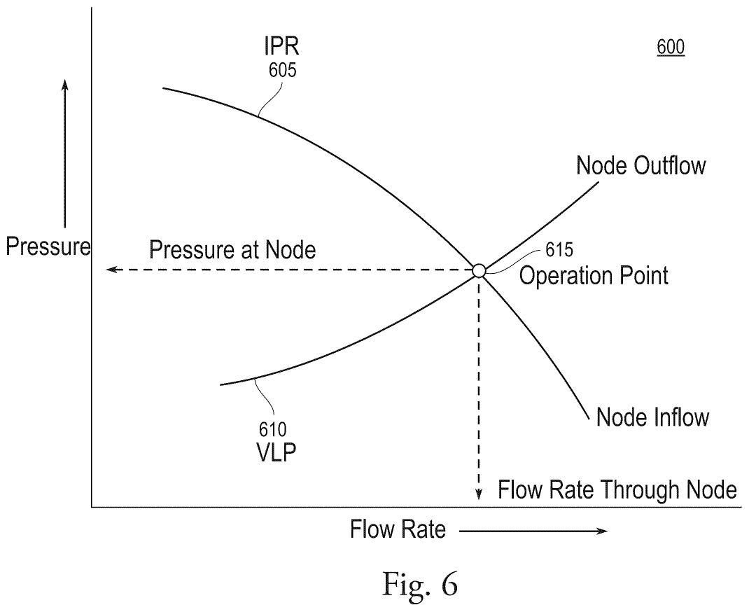

FIG. 6 is a pressure to flow rate graph plot 600 that conceptually illustrates this intersection. As shown in FIG. 6, (IPR) curve 605 intersects with (VLP) curve 610 at an operating point 615. (See FIG. 4, Well Performance. In Production Technology (p. 6).) Curve 605 is a representation that illustrates an output of the IPR model and curve 610 is a representation that illustrates an output of the VLP model. Operating point 615 defines an actual well flow rate and an operating pressure for well performance analysis and, in one example implementation of the present disclosure, for post-stimulation forecasting.

Referring back to FIG. 2, an actual flow rate is determined for each candidate well (102) based on the calibrated well models (e.g., IPR and VLP) that are built at step s210.

Next, process 200 proceeds to step s215, where post-stimulation production increases are forecast for each candidate well (102) based on analyses (e.g., factor sensitivities) conducted using the calibrated well models of step s210.

The Hawkin's formula, equation (3) below, has been used to calculate the skin (S) factor of a well:

$$s = [ \frac{k}{{k}_{skin}} - 1 ] ln ( \frac{{r}_{skin}}{{r}_{w}} ) \qquad ( 3 )$$

where,
i. s=skin factor;
ii. r_{w}=well bore radius, in cm
iii. rₛₖᵢₙ=skin zone radius
iv. k=absolute permeability, in Darcy (or reservoir permeability)
v. kₛₖᵢₙ=skin zone permeability, Darcy

Based on these parameters, a skin factor change of −7 is a widely applicable optimal outcome for an acid stimulation. Thus, in one example implementation, acid stimulation outcome is forecasted at step s215 by repeating the IPR model (see equation (2) above) with a −7 adjustment to the skin factor (S) based on an optimal outcome for post-stimulation well rate for each candidate well (102). In embodiments, a range between −2 to −11 can be assigned for the skin factor adjustment. In alternative implementations, other adjustments can be applied for the post-stimulation forecast of step s215.

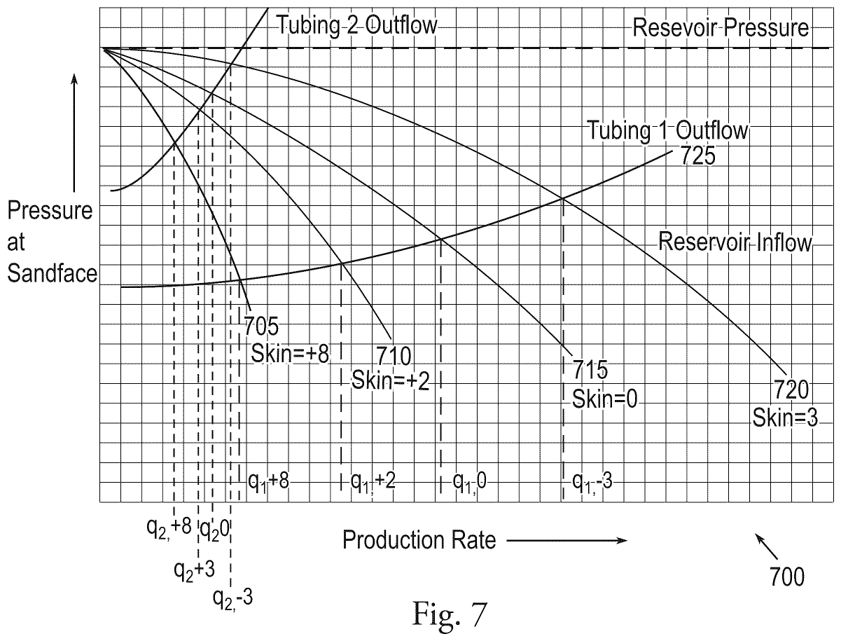

FIG. 7 is a pressure to production rate graph plot 700 that conceptually illustrates this skin factor adjustment. (See FIG. 50, Well Performance. In Production Technology (p. 60).). Curves 705, 710, 715, and 720 are representations that illustrate outputs of the IPR model at different skin factors—+8, +2, 0, and −3, respectively. As shown in FIG. 7, curves 705, 710, 715, and 720 have progressively higher pressure and production rate profiles in correspondence with the decreased skin factor. Consequently, intersections with curve 725, which is a representation of the VLP model output, shift rightward as well. In other words, a negative skin factor shift of the IPR model results in a new operating point with a higher production rate when determining an actual well rate in combination with the VLP model.

Returning to FIG. 2, upon obtaining the forecasted post-stimulation well rates based on skin factor adjustments for each candidate well (102), process 200 continues to step s220 at which reserves calculator records are utilized to project declines rates for the candidate wells 102 based upon which stimulation economic factors (e.g., barrels per dollar cost (bbl/$)) are calculated for ranking the candidate wells 102. According to one example implementation, a pre-stimulation production decline rate is determined and applied to a post-stimulation initial production rate forecasted based on incremental (e.g., producible) reserves.

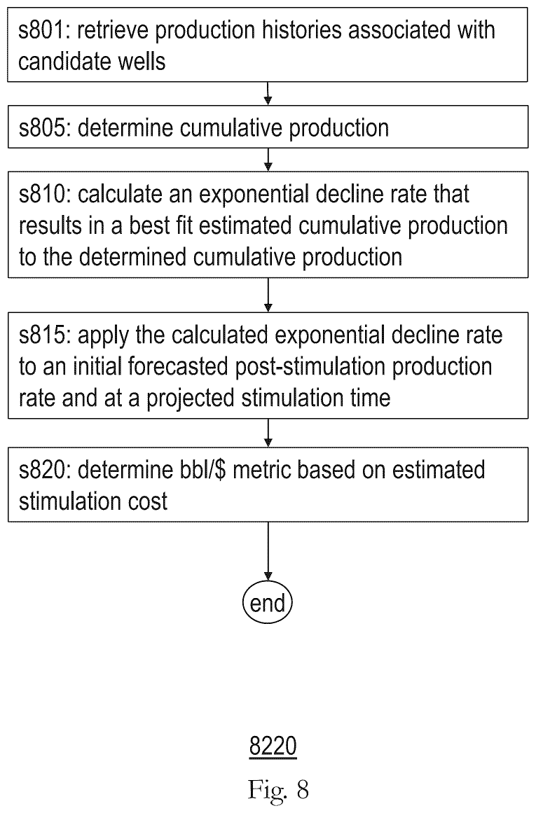

FIG. 8 is a flow diagram of a candidate well stimulation estimation process 8220 that corresponds with step s220 of FIG. 2. In other words, according to one example implementation, process 8220 is performed at step s220 of process 200.

As shown in FIG. 8, process 8220 initiates at step s801 by retrieving the well production histories over a sufficient period (e.g., >=12 months) for the candidate wells (102). In example implementations, the production histories are maintained, at least in part, at one or more of control/data processing apparatus 110, information system 130, and respective control devices (not shown) associated with wells 102.

Next, at step s805, the obtained well production history is used to calculate the cumulative production for each candidate well (102). According to one implementation, this is done by the following equation:

Actual Cumulative Production=Σ (Monthly average rate×Number of days in the month) (4)

In some implementations, production histories across multiple wells (102) from the same reservoir are corroborated for determining the production history and the cumulative production for a particular candidate well (102).

Once the cumulation production is determined, process 8220 proceeds to step s810 and an exponential decline rate is determined based on the calculated cumulative production. In an example implementation, an exponential decline based on Arp's theory on production decline is used to provide a most conservative estimate—when compared to hyperbolic or harmonic decline. The below equation (5) is used to determine the exponential decline rate according to one example implementation.

$$Estimated Cumulative Production = \frac{Q i - Q f}{( Annual Decline Rate / 365. 25 )} where Qi : Initial Flow Rate and Qf : Final Flow Rate \qquad ( 5 )$$

The estimated cumulative production of equation (5) is a best fit estimate (e.g., within an acceptable variance) of the actual cumulative production of equation (4). Thus, the exponential decline rate calculated at step s810 is based on a best fit estimated cumulative production of the cumulative production determined at step s805. In an example implementation, the acceptable variance is in a range between about −3 percent and about +3 percent.

In some implementations, alternative decline rate determinations can be used. For example, increased or decreased decline rates can be used to adjust for specific conditions (e.g., reserves projections, increased decline rates post-stimulation based on reserves in place, and the like) related to a particular candidate well (102).

The calculated exponential decline rate is then applied, at step s815, to the initial production rate for the candidate well (102) post-acid stimulation, which is forecasted at step s215 of process 200. The forecasted initial production rate is set to an approximate date for the potential acid stimulation job (e.g., projected stimulation time) to project a post-stimulation production decline at the calculated exponential decline rate. In implementations of the present disclosure, a same approximate date or different dates can be assigned to respective candidate wells (102).

Once the forecasted post-stimulation production and exponential decline are applied to the approximate stimulation date for each of the candidate wells (102), process 8220 proceeds to step s810, where an incremental reserves over cost (barrels per dollar (bbl/$)) metric is determined.

The cost of acid stimulation is estimated for each candidate well (102) based on the reservoir thickness (h) being stimulated and corresponding volumes of respective chemicals used in the acid recipes. In some implementations, other parameters, such as the skin factor (S) and the like, can be used to estimate the acid stimulation cost.

An incremental reserve for each candidate well (102) is estimated by calculating a cumulative production over a predetermined period based on the post-stimulation production rate and decline profile resulting from step s815. In an example implementation, the predetermined period is the estimated duration for the well to reach the pre-stimulation rate. For example, the predetermined period is set to 32 months if the well is forecasted to take 32 months to decline its increased rate after stimulation and reach the current (pre-stimulation) rate. In certain implementations, the incremental reserve can be determined based on a subtraction of a projected non-stimulated cumulative production from the projected post-stimulation cumulative production. In such implementations, a same or different decline rate can be assigned to the non-stimulated projection. As an example, a lower decline rate can be assigned to the non-stimulated projection so that the projected production rates (non-stimulated and post-stimulation) converge over time.

Table 1 below lists three (3) sample candidate wells (102)—Well 1, Well 2, and Well 3—and their respective incremental reserves (in bo), acid stimulation costs, and bbl/$ metrics determined at step s820.

TABLE 1

| Well Name | Incremental Reserve, bo | Acid Stimulation Cost | bbl/$ |
|---|---|---|---|
| Well 1 | 250,000 | $100,000 | 2.50 |
| Well 2 | 200,000 | $50,000 | 4.00 |
| Well 3 | 175,000 | $75,000 | 2.33 |

Process 8220 ends with the determination of the bbl/$ metric for each candidate well (102).

Referring back to FIG. 2, step s220 is completed and process 200 proceeds to step s225, in which the candidate wells (102) are ranked based on the bbl/$ metric. Table 2 below illustrates an example implementation of step s225 on Table 1, where Well 2 is ranked above Well 1 based on the bbl/$ metric.

TABLE 2

| Well Name | Incremental Reserve, bo | Acid Stimulation Cost | bbl/$ |
|---|---|---|---|
| Well 2 | 200,000 | $50,000 | 4.00 |
| Well 1 | 250,000 | $100,000 | 2.50 |
| Well 3 | 175,000 | $75,000 | 2.33 |

In one example implementation, the ranked candidates at step s225 are recorded at control/data processing apparatus 110 and displayed to an operator via user interface 155 (e.g., apparatus display). In some implementations, the outputs of steps s220 and s225 (e.g., Table 1 and Table 2) are recorded at information system 130. Advantageously, the present disclosure provides an accurate and calibrated bbl/$ metric based upon which costly acid stimulation operations can be prioritized among large numbers of production wells of diverse types in a streamlined and efficient process. Thus, an operator (e.g., engineer) can quickly determine high priority stimulation candidates for further analysis and/or stimulation.

Process 200 concludes by proceeding to step s230 and conducting acid stimulations based on the ranking at step s225 and/or the bbl/$ metric determined at step 220 (e.g., wells above a predetermined bbl/$ threshold range). The predetermined bb/$ threshold and/or range can be set according to performance requirements of an operator. In one example implementation, control/data processing apparatus 110 transmits one or more control signals to the acid stimulation system(s) (107) of the top ranked candidate well(s) to initiate acid stimulation based on parameters (e.g., date, volume, and recipe) determined in processes 200 and 8220. The corresponding acid stimulation system(s) (107), thus, initiates acid stimulation in response to the control signal(s). In some implementations, the control signals can incorporate instructions to onsite operators on the stimulation parameters. Additionally, step s230 can include further detailed review and analysis with respect to top-ranked candidate wells (102) prior to finalizing acid stimulation.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be conducted in any suitable order, or simultaneously.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). To facilitate understanding, like reference numerals have been used, where possible, to designate like elements common to the figures. In certain instances, a letter suffix following a dash ( . . . -b) denotes a specific example of an element marked by a particular reference numeral (e.g., 210-b). Description of elements with references to the base reference numerals (e.g., 210) also refer to all specific examples with such letter suffixes (e.g., 210-b), and vice versa.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof, and are meant to encompass the items listed thereafter and equivalents thereof as well as additional items.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting.

While the disclosure has described several example implementations, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for conducting this disclosure, but that the disclosure will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope encompassed by the present disclosure, which is defined by the set of recitations in the following claims and by structures and functions or steps which are equivalent to these recitations.

What is claimed is:

1. A method of prioritizing candidate natural resource production wells for acid stimulation, comprising:
(1) receiving, by one or more processing apparatuses via a communication interface, well testing information associated with a plurality of natural resource production wells;
(2) identifying, by the one or more processing apparatuses, a respective skin factor for each of the plurality of natural resource production wells;
(3) modeling, by the one or more processing apparatuses, an inflow performance relationship and a vertical lift performance for each of the plurality of natural resource production wells based on the identified respective skin factor;
(4) forecasting, by the one or more processing apparatuses, a post-stimulation production increase based on the modeled inflow performance relationship, the modeled vertical lift performance, and a predetermined skin factor adjustment;
(5) determining, by the one or more processing apparatuses, an incremental reserve over cost metric for each of the plurality of natural resource production wells based on the forecasted post-stimulation production increase;
(6) ranking, by the one or more processing apparatuses, the plurality of natural resource production wells according to the determined incremental reserve over cost metric; and
(7) outputting, by the one or more processing apparatuses via the communication interface, one or more control signals adapted to initiate acid stimulation of one or more top-ranked natural resource production wells.

2. The method of claim 1, wherein the (5) determining comprises:
a. retrieving, by the one or more processing apparatuses, production histories of the plurality natural resource production wells;
b. determining, by the one or more processing apparatuses, a cumulative production for each of the plurality natural resource production wells based the retrieved production histories;
c. calculating, by the one or more processing apparatuses, a decline rate based on a relationship between an outcome of the decline rate and the determined cumulative production for each of the plurality natural resource production wells;
d. applying, by the one or more processing apparatuses, the calculated decline rate to an initial production rate associated with the forecasted post-stimulation production increase for each of the plurality of natural resource production wells; and
e. determining, by the one or more processing apparatuses, the incremental reserve over cost metric based on an estimated stimulation cost and a projected production from the applied decline rate.

3. The method of claim 2, wherein the decline rate is an exponential decline rate.

4. The method of claim 2, wherein the outcome of the decline rate is an estimated cumulative production associated with the decline rate.

5. The method of claim 4, wherein the relationship between the outcome of the decline rate and the determined cumulative production is a best fit between the estimated cumulative production associated with the decline rate and the determined cumulative production.

6. The method of claim 5, wherein the best fit corresponds to being within an acceptable variance ranging between about −3 percent and about +3 percent.

7. The method of claim 2, wherein the calculated decline rate is applied to the initial production rate at a projected stimulation time.

8. The method of claim 2, wherein the incremental reserve over cost metric incorporates a projected non-stimulated production for each of the plurality of natural resource production wells.

9. The method of claim 1, further comprising:
(8) initiating, by one or more acid stimulation systems, acid stimulation of the one or more top-ranked natural resource production wells based on one or more parameters included in the one or more control signals.

10. An apparatus adapted to prioritize candidate natural resource production wells for acid stimulation, comprising:
(a) a processor;
(b) a communication interface to one or more networks; and
(c) a non-transitory computer-readable memory operatively connected to the one or more processors and having stored thereon machine-readable instructions to:
(1) receive, via the communication interface, well testing information associated with a plurality of natural resource production wells;
(2) identify a respective skin factor for each of the plurality of natural resource production wells;
(3) model an inflow performance relationship and a vertical lift performance for each of the plurality of natural resource production wells based on the identified respective skin factor;
(4) forecast a post-stimulation production increase based on the modeled inflow performance relationship, the modeled vertical lift performance, and a predetermined skin factor adjustment;
(5) determine an incremental reserve over cost metric for each of the plurality of natural resource production wells based on the forecasted post-stimulation production increase;
(6) rank the plurality of natural resource production wells according to the determined incremental reserve over cost metric; and
(7) output, via the communication interface, one or more control signals adapted to initiate acid stimulation of one or more top-ranked natural resource production wells.

11. The apparatus of claim 10, wherein the machine-readable instructions further comprise, for the (5) determine element, instructions to:
a. retrieve production histories of the plurality natural resource production wells;
b. determine a cumulative production for each of the plurality natural resource production wells based the retrieved production histories;
c. calculate a decline rate based on a relationship between an outcome of the decline rate and the determined cumulative production for each of the plurality natural resource production wells;
d. apply the calculated decline rate to an initial production rate associated with the forecasted post-stimulation production increase for each of the plurality of natural resource production wells; and
e. determine the incremental reserve over cost metric based on an estimated stimulation cost and a projected production from the applied decline rate.

12. The apparatus of claim 11, wherein the decline rate is an exponential decline rate.

13. The apparatus of claim 11, wherein the outcome of the decline rate is an estimated cumulative production associated with the decline rate.

14. The apparatus of claim 13, wherein the relationship between the outcome of the decline rate and the determined cumulative production is a best fit between the estimated cumulative production associated with the decline rate and the determined cumulative production.

15. The apparatus of claim 14, wherein the best fit corresponds to being within an acceptable variance ranging between about −3 percent and about +3 percent.

16. The apparatus of claim 11, wherein the calculated decline rate is applied to the initial production rate at a projected stimulation time.

17. The apparatus of claim 11, wherein the incremental reserve over cost metric incorporates a projected non-stimulated production for each of the plurality of natural resource production wells.

18. A system comprising:
the apparatus according to claim 10; and
one or more acid stimulation systems adapted to initiate acid stimulation of the one or more top-ranked natural resource production wells based on one or more parameters included in the one or more control signals.
